(19) United States
(12) Patent Application Publication
(10) Pub. No.: US 2011/0041145 A1
(43) Pub. Date: Feb. 17, 2011

(54) Spindle motor for optical disc drive

(76) Inventors: Shih-Lin Yeh, Hsinchu (TW); Chun-Lung Ho, Hsinchu (TW)

Correspondence Address: Raymond Sun, 12420 Woodhall Way, Tustin, CA, 92782, US

(21) Appl. No.: 12/590,077

(22) Filed: Nov. 2, 2009

(30) Foreign Application Priority Data
Aug. 17, 2009 (CN) 200910167044.2

(51) Int. Cl. G11B 17/028

(52) U.S. Cl. 720/695; G9B/25; G9B/17

(57) ABSTRACT

The present invention provides a spindle motor for an optical disc drive. The spindle motor comprises a turntable unit and an anti-slipping element. The turntable unit has a disc mounting stand, which has a first outer diameter. The anti-slipping element is disposed on said turntable unit and has a first inner diameter, wherein the difference between the first outer diameter and the first inner diameter is less than or equal to 8 mm.

### FIELD OF THE INVENTION

The present invention relates to a spindle motor, and more particularly to a spindle motor used in an optical disc drive.

### BACKGROUND OF THE INVENTION

During the developing process of the optical disc drive, the requirement of the read/write speed of the optical disc drive is higher and higher. In order to catch up the read/write speed, the rotating speed of the spindle motor used for rotating the optical disc in the optical disc drive should be raised accordingly. However, some problems may result from the high rotating speed, for example, the noise problem, the disc vibration problem, the disc crash problem, and so on.

In the present optical disc drive, it usually contains a spindle motor. Please refer to FIG. 1 and FIG. 2. FIG. 1 shows a diagram of a spindle motor 100, an optical disc 200 and a disc damper 300 of a present optical disc drive, and FIG. 2 shows a cross-section diagram of the spindle motor 100 of the present optical disc drive.

The spindle motor 100 comprises a motor unit 110 and a turntable unit 120. The motor unit 110 has a stator 111, a rotor 112 and a rotating shaft 113. When providing electric current to the motor unit 100, the rotor 112 and the rotating shaft 113 start to rotate relating to the stator 111. The turntable unit 120 is disposed on the rotating shaft 113 and connects to the motor unit 110 though the rotating shaft 113. When the rotating shaft 113 starts to rotate, the turntable unit 120 is driven to rotate together with the rotating shaft 113.

The turntable unit 120 has a disc supporting surface 121 and a disc mounting stand 122. The disc mounting stand 122 has a plurality of elastic elements 123. When the optical disc 200 is placed on the disc supporting surface 121, a central hole 210 of the optical disc 200 is mounted on the disc mounting stand 122, and the elastic elements 123 press on the periphery of the central hole 210 for fixing and centering the optical disc 200 on turntable unit 120. Moreover, the disc clamper 300 disposed above the spindle motor 100 clamps the optical disc 200 with the turntable unit 120 by, for example, the magnetic force.

Please refer to FIG. 3. FIG. 3 shows a diagram of the optical disc placed on the turntable unit under a high rotating speed. In the present spindle motor 100, the disc supporting surface 121 of the turntable unit 120 is a ring-shape and disposed at the outside periphery of the turntable unit 120. When the optical disc 200 is clamped between the clamper 300 (not shown in FIG. 3) and the turntable unit 120, a clamping force is applied on a clamping point 220 of the optical disc 200 which is located above the disc supporting surface 121. Further, the inside periphery of the optical disc 200 is suspended. Therefore, as the vibrating amount of the optical disc 200 increases due to the high rotating speed, the outside periphery of the optical disc 200 and the portion of the optical disc 200 near the central hole 210 vibrate up and down by taking the clamping point 220 as a fulcrum. The vibrating force causes a plurality cracks happened near the central hole 210 of the optical disc 200, and the cracks gradually spread to the whole optical disc 200. Finally, the optical disc 200 may burst apart.

### SUMMARY OF THE INVENTION

Accordingly, the object of the present invention is to provide a spindle motor for an optical disc drive which can clamp an optical disc more steadily and can reduce the vibrating amount of the optical disc under a high rotating speed. Therefore, the cracks happened on the optical disc is avoided, and the problem of the burst of the optical disc is solved.

The present invention provides a spindle motor for an optical disc drive. The spindle motor comprises a turntable unit and an anti-slipping element. The turntable unit has a disc mounting stand, which has a first outer diameter. The anti-slipping element is disposed on said turntable unit and has a first inner diameter, wherein the difference between the first outer diameter and the first inner diameter is less than or equal to 8 mm.

The present invention further provides a spindle motor for an optical disc drive. The spindle motor comprises a turntable unit and an anti-slipping element. The turntable unit has a disc supporting surface for supporting an optical disc. The anti-slipping element is disposed on the disc supporting surface and covers over the disc supporting surface.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic view of a spindle motor, an optical disc and a disc clamper of a present optical disc drive;

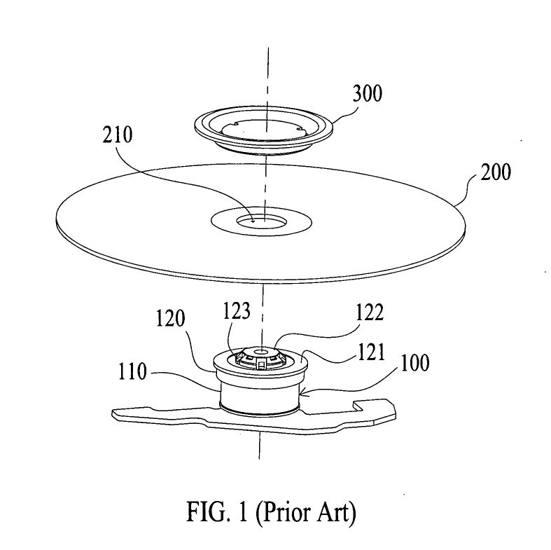

FIG. 2 is a cross-section view of the spindle motor of the present optical disc drive;

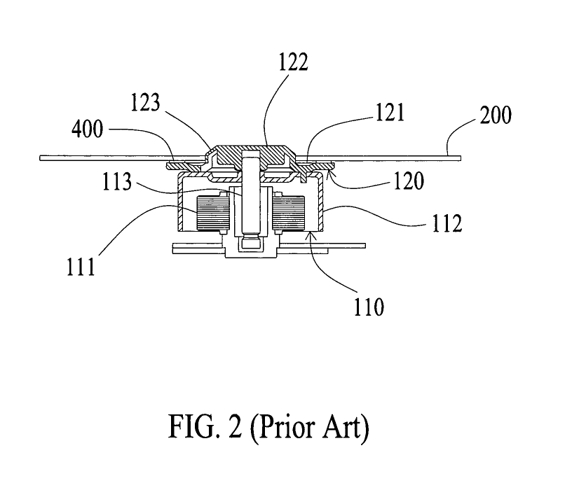

FIG. 3 is schematic view of the optical disc placed on the turntable unit under a high rotating speed;

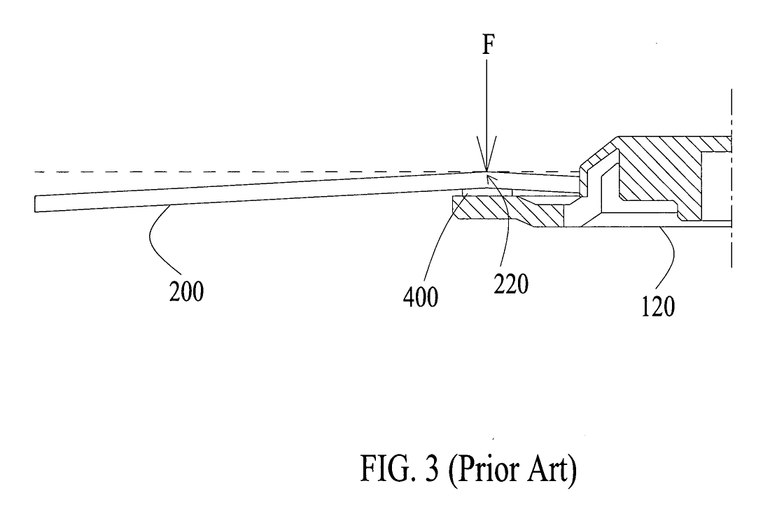

FIG. 4 is schematic view of a spindle motor according to the preferred embodiment of the present invention; and

FIG. 5 is schematic view of the optical disc placed on the turntable unit under a high rotating speed according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

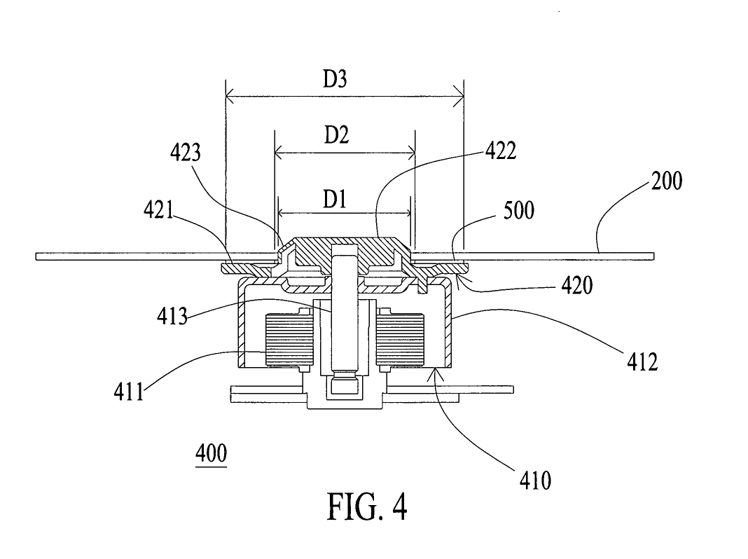

Please refer to FIG. 4, which shows a schematic view of a spindle motor 400 according to the preferred embodiment of the present invention. The spindle motor 400 comprises a motor unit 410, a turntable unit 420 and an anti-slipping element 500. The motor unit 410 includes a stator 411, a rotor 412 and a rotating shaft 413. When providing electric current to the motor unit 410, the rotor 412 and the rotating shaft 413 start to rotate relating to the stator 411. The turntable unit 420 is disposed on the rotating shaft 413 and connects to the motor unit 410 though the rotating shaft 413. When the rotating shaft 413 starts to rotate, the turntable unit 420 is driven to rotate together with the rotating shaft 413. Moreover, the turntable unit 420 has a disc supporting surface 421 and a disc mounting stand 422. The disc mounting stand 422 has a plurality of elastic elements 423, and the anti-slipping element 500 is disposed on the disc supporting surface 421.

When the optical disc 200 is placed on the spindle motor 400, a central hole 210 of the optical disc 200 is mounted on the disc mounting stand 422, and the elastic elements 423 press on the periphery of the central hole 210 for fixing and centering the optical disc 200 on turntable unit 420. Therefore, the center of the optical disc 200 is aligned with the rotating axis of the spindle motor 400. Moreover, as the optical disc 200 is placed on the spindle motor 400, a portion of the optical disc 200 near the central hole 210 is placed on the anti-slipping element 500.

According to the preferred embodiment of the present invention, the peripheral shape of the disc mounting stand 422 is approximately circular for fitting with the central hole 210 of the optical disc 200, and the shape of the disc supporting surface 421 and the anti-slipping element 500 is approximately annular. The disc mounting stand 422 has an outer diameter D1, and the anti-slipping element 500 has an inner diameter D2 and an outer diameter D3. The difference between the outer diameter D1 of the disc mounting stand 422 and the inner diameter D2 of the anti-slipping element 500 is less than or equal to 8 mm.

According to the preferred embodiment of the present invention, it also can further set the difference between the inner diameter D2 and the outer diameter D3 of the anti-slipping element 500 to be greater than or equal to 8 mm.

In an another aspect of the preferred embodiment of the present invention, the anti-slipping element 500 can be disposed on the disc supporting surface 421 and cover over the disc supporting surface 421.

Based on the spindle motor provided in the present invention, when an optical disc is placed on the turntable unit, because the bottom surface of the optical disc near the central hole is supported by the anti-slipping element, the vibrating amount of the optical disc near the central hole can be reduced as the optical disc is under a high rotating speed, therefore, to avoid the cracks happened.

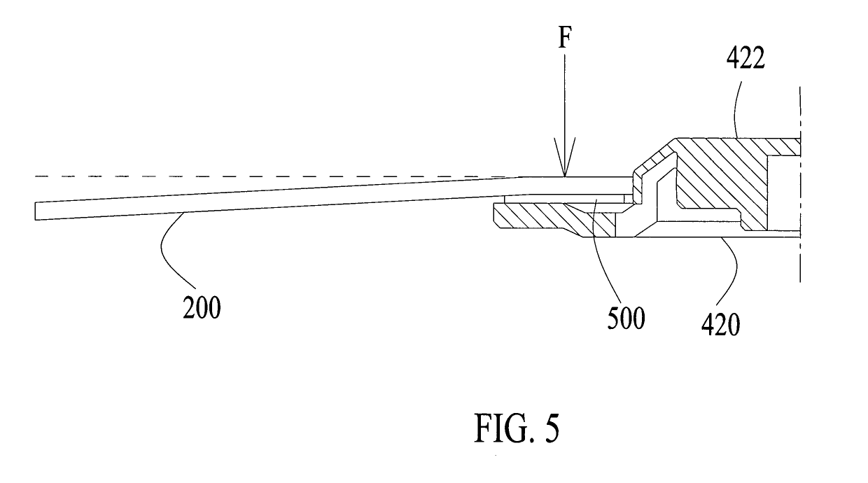

Please refer to FIG. 5, which shows a schematic view of the optical disc placed on the turntable unit under a high rotating speed according to the present invention. When the optical disc 200 is placed on the turntable unit 420 and is rotated at high rotating speed, the portion of the optical disc 200 near the central hole 210 is clamped by a clamper (not shown in figure) and is supported by the anti-slipping element 500, so the vibration amount of the optical disc near the central hole 210 is almost zero. Therefore, the cracks happened on the optical disc near the central hole is efficiently avoided.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A spindle motor for an optical disc drive, comprising:
a turntable unit, having a disc mounting stand, wherein said disc mounting stand has a first outer diameter; and
an anti-slipping element, disposed on said turntable unit and having a first inner diameter, wherein the difference between said first outer diameter and said first inner diameter is less than or equal to 8 mm.

2. The spindle motor according to claim 1, further comprising a motor unit, which has a rotating shaft, wherein said turntable unit is connected to said motor unit by said rotating shaft.

3. The spindle motor according to claim 1, wherein said anti-slipping element has a second outer diameter, and the difference between said second outer diameter and said first inner diameter is greater than or equal to 8 mm.

4. A spindle motor for an optical disc drive, comprising:
a turntable unit, having a disc supporting surface for supporting an optical disc; and
an anti-slipping element, disposed on said disc supporting surface and covering over said disc supporting surface.

5. The spindle motor according to claim 4, wherein said disc supporting surface and said anti-slipping element are annular.
